(19) United States
(12) Patent Application Publication
(10) Pub. No.: US 2026/0349805 A1
(43) Pub. Date: Nov. 5, 2026

(54) Dynamic Orchestration of Multi-Agent AI Workflows

(71) Applicant: ServiceNow, Inc., Santa Clara, CA (US)

(72) Inventors: Yash Saxena, Santa Clara, CA (US); Ziaul Hasan Hashmi, Kirkland, WA (US); Srivatsava Daruru, San Jose, CA (US); Kiran Kumar Ramanna, Milpitas, CA (US); Seyederfan Hosseini, Toronto (CA); Binay Singh Chawla, Sunnyvale, CA (US); Prashanti Nilayam, Manteca, CA (US); Ashok Ganesan, Leander, TX (US); Prashil Tumbade, San Jose, CA (US); Bassem Makni, Edmonton (CA)

(21) Appl. No.: 19/194,444

(22) Filed: Apr. 30, 2025

(51) Int. Cl. G06F 9/50

(52) U.S. Cl. CPC G06F 9/5027

(57) ABSTRACT

A method includes receiving a user query and determining a first agentic task of a plurality of agentic tasks to perform based on the user query. The method includes selecting a first AI agent from a plurality of AI agents based on the first agentic task and performing the first agentic task using the first AI agent. Based on the user query and performance of the first agentic task, the method includes determining a second agentic task of the plurality of agentic tasks to perform. The method includes selecting a second AI agent based on the second agentic task from the plurality of AI agents and performing the second agentic task using the second AI agent.

### TECHNICAL FIELD

This disclosure relates to multi-agent workflows.

### BACKGROUND

Various technical challenges are associated with a virtual assistant efficiently handling a complex user query. For example, the virtual assistant may perform multiple, interdependent processing steps. However, the virtual assistant is often limited to addressing a simple, isolated question or executing a predefined, static workflow, although many real-world scenarios require the execution of multiple, interdependent tasks.

### SUMMARY

One implementation of the disclosure provides a computer-implemented method of orchestrating multi-agent workflows. The method includes receiving a user query and determining a first agentic task of a plurality of agentic tasks to perform based on the user query. The method includes selecting a first artificial intelligence (AI) agent based on the first agentic task from a plurality of AI agents and performing the first agentic task using the first AI agent. Based on the user query and performance of the first agentic task, the method includes determining a second agentic task of the plurality of agentic tasks to perform. The method includes selecting a second AI agent based on the second agentic task from the plurality of AI agents and performing the second agentic task using the second AI agent.

Implementations of the disclosure may include one or more of the following optional features. In some implementations, selecting the first AI agent is based on a respective capability associated with the first AI agent and selecting the second AI agent is based on a respective capability associated with the second AI agent. Here, the respective capability associated with the first AI agent is different from the respective capability associated with the second AI agent. In some examples, the user query includes a plurality of intents where the first agentic task is associated with a first intent of the plurality of intents. The second agentic task is associated with a second intent of the plurality of intents. In these examples, determining the first agentic task may include identifying dependencies between the plurality of intents and prioritizing tasks based on the identified dependencies. The method may further include determining that each agentic task of the plurality of agentic tasks is complete and generating results for the user query based on determining that each agentic task of the plurality of agentic tasks is complete.

In some implementations, determining the first agentic task is further based on a conversational context associated with the user query. The conversational context includes information from one or more previously performed agentic tasks and one or more previously received user queries. In these implementations, determining the first agentic task may include generating, using a large language model (LLM), a structured output that includes a chain of thought (CoT) reasoning and an identification of the first agentic task. The CoT reasoning analyzes the user query and the conversational context. The plurality of AI agents may include at least one of a task management agent, a summarization agent, an email agent, a scheduling agent, or a question answering agent. Here, the question answering agent is configured to utilize retrieval-augmented generation (RAG) based on one or more knowledge sources.

In some examples, the method further includes performing a semantic search based on the user query and retrieving supplemental information based on the semantic search. Performing the first agentic task is based on the supplemental information. Determining the first agentic task may include determining to route the first agentic task to at least one of a RAG pipeline, a respective AI agent utilizing only a conversational context, or a respective AI agent configured to perform the first agentic task. In some implementations, the method further includes determining that a task result of performing the first agentic task presents multiple distinct options requiring user selection to proceed, transmitting data representing the multiple distinct options to a user device associated with the user query, and receiving an input selection indicating the user selection. In these implementations, determining the second agentic task of the plurality of agentic tasks to perform may be further based on the input selection.

Before determining the second agentic task, the method may further include determining that each agentic task of the plurality of agentic tasks is not complete. Here, determining the second agentic task is further based on determining that each agentic task of the plurality of agentic tasks is not complete. In some examples, performing the first agentic task includes generating a task result based on performing the first agentic task. In these examples, determining the second agentic task may be further based on the task result. The first agentic task may include a next best action. In some implementations, determining the second agentic task occurs after performing the first agentic task.

Another implementation of the disclosure provides a system that includes data processing hardware and memory hardware storing instructions that when executed on the data processing hardware causes the data processing hardware to perform operations. The operations include receiving a user query and determining a first agentic task of a plurality of agentic tasks to perform based on the user query. The operations include selecting a first artificial intelligence (AI) agent based on the first agentic task from a plurality of AI agents and performing the first agentic task using the first AI agent. Based on the user query and performance of the first agentic task, the operations include determining a second agentic task of the plurality of agentic tasks to perform. The operations include selecting a second AI agent based on the second agentic task from the plurality of AI agents and performing the second agentic task using the second AI agent.

Another implementation of the disclosure provides a computer-readable medium having instructions that, when executed by data processing hardware, causes the data processing hardware to perform operations. The operations include receiving a user query and determining a first agentic task of a plurality of agentic tasks to perform based on the user query. The operations include selecting a first artificial intelligence (AI) agent based on the first agentic task from a plurality of AI agents and performing the first agentic task using the first AI agent. Based on the user query and performance of the first agentic task, the operations include determining a second agentic task of the plurality of agentic tasks to perform. The operations include selecting a second AI agent based on the second agentic task from the plurality of AI agents and performing the second agentic task using the second AI agent.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system executing a query orchestrator to orchestrate performance of a user query.

FIG. 2 is a schematic view of an example process performed by the query orchestrator.

FIG. 3 is a flowchart of an example arrangement of operations for a computer-implemented method of orchestrating multi-agent workflows.

FIG. 4 is a schematic view of an example computing device that may be used to implement the systems and methods described herein.

Like reference symbols in the various drawings indicate like elements.

### DETAILED DESCRIPTION

Conversational artificial intelligence (AI) systems, including virtual assistants, are increasingly integrated into enterprise operational workflows and consumer technology, leading users to expect sophisticated interactions beyond simple commands. Users frequently issue complex natural language queries that encompass multiple distinct intents or necessitate a sequence of interdependent actions for complete resolution. However, traditional virtual assistant architectures often struggle with such complexity, typically being designed for single-intent mapping or reliance on predefined, static workflows. This inherent limitation means traditional virtual assistant architectures cannot readily handle interdependent combinations of requests, and the manual creation of static workflows covering the vast combinatorial space of potential multi-step queries is practically infeasible, restricting flexibility and adaptability when faced with the nuances of natural user interaction.

Recognizing these limitations, more advanced orchestration techniques attempt to coordinate multiple specialized AI agents or system functions. A common strategy involves generating a complete, multi-step execution plan immediately upon receiving a complex query. While seemingly structured, this upfront planning suffers from significant practical drawbacks that hinder effective conversational interaction. The process may introduce substantial latency due to the computational cost of analysis and plan generation, conflicting with user expectations for real-time responsiveness. Moreover, these comprehensive plans often suffer from unexpected results or new information emerging during the conversation that invalidates the entire remaining pre-planned sequence. This necessitates discarding the plan and initiating a costly and time-consuming re-planning process. Compounding these issues are the persistent difficulties in dynamically managing task dependencies and maintaining coherent conversational context across the disparate components involved in executing the plan.

To that end, implementations herein are directed to a query orchestrator that receives a user query that includes a plurality of intents and determines a first agentic task of a plurality of agentic tasks to perform based on the user query. The query orchestrator selects a first AI agent from a plurality of AI agents based on the first agentic task and performs the first agentic task using the first AI agent. Based on the user query and performing the first agentic task, the query orchestrator determines a second agentic task of the plurality of agentic tasks to perform. The query orchestrator selects a second AI agent from the plurality of AI agents based on the second agentic task and performs the second agentic task using the second AI agent. The query orchestrator determines that each agentic task of the plurality of agentic tasks is complete and generates results for the user query based on determining that each agentic task is complete.

Advantageously, by determining only a current or next task based on the immediate context, the query orchestrator reduces the computational overhead and processing time required before initiating the first action. This improves the responsiveness of the system, allowing for faster initiation of task execution and aligning better with the real-time nature of conversational interactions. The iterative determination process also leads to more efficient utilization of computational resources, as the system avoids the potentially expensive generation of complex, multi-step plans that may ultimately need to be discarded if circumstances change mid-execution.

Moreover, the context-driven task determination enhances the adaptability and robustness of the system when handling the dynamic and often unpredictable nature of user interactions and task execution. Unlike systems reliant on upfront plans, where a single unexpected outcome may necessitate complete and costly re-planning, the query orchestrator is able to readily adjust its determination of the next task based on the actual results and updated context from the previous step. This inherent adaptability allows the system to handle errors, changing user intents, or unexpected information more gracefully, leading to a more reliable and fault-tolerant execution process specifically tailored to complex query resolution.

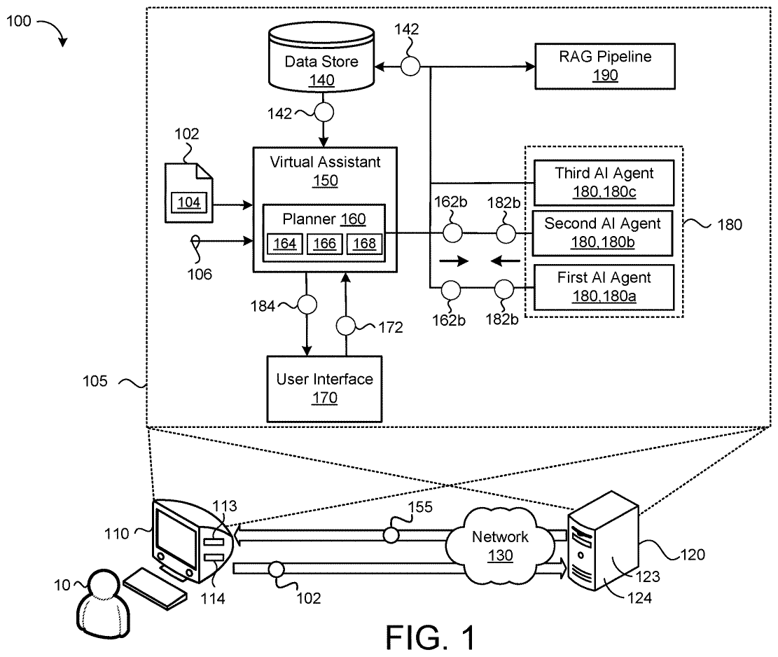

FIG. 1 illustrates an example system 100 including a query orchestrator 105 that allows a virtual assistant 150 to interact with different specialized AI agents 180 to perform actions on behalf of a user 10 associated with the virtual assistant 150. Three AI agents 180 are shown in FIG. 1 for the sake of clarity, as it is understood that the system 100 may interact with and/or manage interactions with any number of AI agents 180. Generally, the user 10 inputs, via a user device 110, a user query 102 to the virtual assistant 150 specifying a user query 102, which may include a plurality of intents 104 that the user 10 wants the virtual assistant 150 to perform on behalf of the user 10. An intent 104 refers to a specific goal or purpose implied within the user query 102. For instance, the user 10 may ask the virtual assistant 150 to “summarize all tasks assigned to me.” Here, the single user query 102 may require access to multiple sources to provide a consolidated overview of pending work items. The virtual assistant 150 selects one or more AI agents 180 to interact with to fulfill the user query 102 (i.e., complete the tasks required by the user query 102). Fulfillment of the user query 102 may require performance of multiple agentic tasks 162 that collectively define the path to resolving the user query 102. An agentic task 162 represents a discrete unit of work delegated to a particular AI agent 180. For example, resolving “summarize all tasks assigned to me” may involve agentic tasks 162 such as identifying the systems where tasks may be assigned (e.g., project management tool, email application, calendar entries), querying each identified system for tasks assigned to the user 10, and consolidating and summarizing the findings.

As such, the virtual assistant 150, guided by the query orchestrator 105, selects appropriate AI agents 180 to perform the agentic tasks 162 necessary to fulfill the intents 104 specified by the user query 102. For example, the virtual assistant 150 may select a specialized project management AI agent 180 for querying a specific tool, an email AI agent 180 for checking flagged messages, a calendar AI agent 180, and a summarization AI agent 180 to combine the results. For each selected AI agent 180, the virtual assistant 150 issues the corresponding agentic task 162 to perform. The virtual assistant 150 may facilitate, with or without involving direct input from the user 10, multiple interactions with the AI agents 180 until the user query 102 is resolved. Based on the task results 182 received from the AI agents 180, the virtual assistant 150 is configured to provide, for output from the user device 110, results 155 for the user query 102. The user device 110 may audibly output, from an audio output device (e.g., acoustic speaker), the results 155 as synthesized speech. Additionally or alternatively, the user device 110 may display, on a screen in communication with the user device 110, graphics, text, and/or other visual information that conveys the details of the results 155.

The system 100 includes the user device 110, a remote computing system 120, and a network 130. The user device 110 includes data processing hardware 113 and memory hardware 114. The user 10 may input a textual or spoken representation of the user query 102 via a user interface 170 executing on the user device 110. The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the query orchestrator 105 includes a data store 140, the virtual assistant 150, the user interface 170, a plurality of AI agents 180, and a retrieval-augmented generation (RAG) pipeline 190. The virtual assistant 150 may employ or be in communication with a planner 160. The virtual assistant 150 receives the user query 102 from the user device 110. The user query 102 includes or implies the plurality of intents 104 (e.g., the intent 104 to retrieve information and the intent 104 to summarize tasks). Based on receiving the user query 102, the planner 160 determines a plurality of agentic tasks 162 to perform to resolve the user query 102. Notably, unlike static workflow systems or approaches employing full upfront planning where a complete sequence of tasks are determined before execution begins, the planner 160 operates dynamically and iteratively. In particular, the planner 160 may focus on determining only the immediate next best action (e.g., the next agentic task 162) to perform based on the current state of the interaction. This iterative approach provides significant advantages. For instance, determining the entire sequence upfront may be computationally expensive and not adaptable, errors or unexpected outcomes during the execution of an early task may invalidate the remainder of a pre-computed plan, requiring computationally expensive re-planning. By contrast, the planner 160 may determine only the next agentic task 162 at each step which is computationally efficient and inherently adaptable to unforeseen circumstances encountered during execution. Thus, each subsequent agentic task 162 determination is based on performing one or more prior agentic tasks 162 and the associated task results 182 received.

The planner 160 initially determines a first agentic task 162, 162a of the plurality of agentic tasks 162 to perform based on the user query 102. Importantly, determining the first agentic task 162a includes determining how to route the agentic task 162 for execution. The planner 160 may determine routing the agentic task 162 to at least one of the RAG pipeline 190, a respective AI agent 180 utilizing only a conversational context 106, or a respective AI agent 180 configured to perform the first agentic task 162a.

The plurality of AI agents 180 may include at least one of a task management agent that interfaces with project tools, a summarization agent that condenses text, an email agent that reads and sends emails, a scheduling agent that manages calendars, or a question answering agent. The question answering agent may be configured to utilize RAG via the RAG pipeline 190 based on one or more knowledge sources (e.g., querying the data store 140). Alternatively, the planner 160 may determine that the agentic task 162 may be handled by a respective AI agent 180 utilizing only the conversational context 106 without requiring specialized tools or external data retrieval. The first agentic task 162a may be associated with a first intent 104 of the plurality of intents 104. In some implementations, the planner 160 identifies dependencies 164 between the plurality of intents 104 or, more granularly, between agentic tasks 162 needed to fulfill the intents 104. The dependencies represent logical or data-flow constraints (e.g., task B requires output from task A). The planner 160 prioritizes and/or sequences tasks based on the identified dependencies 164. For example, the agentic task 162 of “Summarize retrieved tasks” is dependent on the successful completion of the agentic tasks 162 responsible for retrieving the tasks from the individual sources (e.g., project tool, email). The planner 160 ensures that the retrieval agentic tasks 162 are performed before attempting the summarization agentic task 162.

In some examples, the planner 160 determines each subsequent agentic task 162 based on an evolving conversational context 106 associated with the user query 102. The conversational context 106 functions as a short-term memory or state repository for ongoing interactions. The conversational context 106 may be dynamically updated as each agentic task 162 is performed and as task results 182 become available. Thus, the conversational context 106 acts as a memory or state tracker for the interaction, which may include information from one or more previously performed agentic tasks 162, the task results 182 obtained so far, and one or more previously received user queries 102.

The planner 160 may determine each agentic task 162 by generating, using a sequence processing neural network, a structured output 166 that includes a chain of thought (CoT) reasoning and an identification 168 of the agentic task 162. The sequence processing neural network may include, for example, a large language model (LLM). The CoT reasoning analyzes the user query 102, the conversational context 106, and identified dependencies 164. That is, the CoT reasoning serves as a justification for the selection of the subsequent agentic task 162.

In some implementations, especially if the user query 102 is underspecified, ambiguous, or requires external knowledge not present in the immediate context, the virtual assistant 150 or planner 160 performs a semantic search based on the user query 102 and/or the current conversational context 106 and retrieves supplemental information 142 from the data store 140 or external sources via the RAG pipeline 190. Here, the AI agent 180a may perform the agentic task 162 based on the supplemental information 142. For example, if the user query 102 is “Schedule a meeting with John about Project Alpha,” the planner 160 may use RAG to query the data store 140 (e.g., contacts) to find John's full name, email address, or availability (i.e., supplemental information 142). The planner 160 incorporates the supplemental information to fully parameterize the “schedule meeting” agentic task 162 before dispatching the agentic task 162 to the appropriate scheduling AI agent 180. Thereafter, the AI agent 180 performs the parameterized agentic task 162 which is based on the supplemental information 142.

Thereafter, the planner 160 selects a first AI agent 180, 180a from the plurality of AI agents 180 based on the first agentic task 162a. Selection of the first AI agent 180a is based on a respective capability associated with the first AI agent 180a matching the requirements of the first agentic task 162a (e.g., function type, required inputs, expected outputs). For example, if the first agentic task 162a is “identify configured task sources for the user,” the planner 160 selects a user profile AI agent 180 with the capability of accessing user settings or configurations stored in the data store 140. The first AI agent 180a then performs the first agentic task 162a producing first task results 182a. Notably, the first task results 182a may not always include expected results. That is, the first task results 182a may include errors, indicate a failure to complete the agentic task 162, or reveal unexpected information that impacts how the overall user query 102 should be further processed.

The planner 160 determines a second agentic task 162, 162b of the plurality of agentic tasks 162 to perform based on the user query 102, the updated conversational context 106 incorporating the first task results 182a (e.g., including any errors or unexpected outcomes), an assessment of the remaining unresolved intents 104, and performance of the first agentic task 162a. That is, the planner 160 determines the second agentic task 162b after performing the first agentic task 162a and evaluating the first task results 182a. This exemplifies the advantage of the iterative approach employed by the query orchestrator 105. That is, the query orchestrator 105 dynamically adapts the next agentic task 162 based on prior task results 182, rather than adhering to a potentially invalid pre-defined or pre-determined plan. If the first agentic task 162a failed or produced unexpected results (e.g., an error occurred), the planner 160 may determine the second agentic task 162b that is configured to handle the error, seek clarification, or try an alternative approach, enhancing robustness and computational efficiency compared to recalculating an entire sequence.

The example shown in FIG. 1 includes two agentic tasks 162 for the sake of clarity, however, it is understood that this iterative process continues until all intents 104 are addressed, meaning any number of agentic tasks may be performed sequentially or concurrently as dependencies 164 permit. The second agentic task 162b may be associated with a second intent 104 of the plurality of intents 104 or associated with a subsequent step needed to fulfill the first intent 104. Before determining any subsequent agentic task (such as the second agentic task 162b), the planner 160 determines if all agentic tasks 162 required to satisfy the user query 102 (considering dependencies and context) are complete. Determining the second agentic task 162b (or any subsequent task) is therefore based on determining that not all required agentic tasks are yet complete. The planner 160 selects a second AI agent 180, 180b based on the second agentic task 162b. Selection of the second AI agent 180b is based on a respective capability associated with the second AI agent 180b whereby the respective capability associated with the first AI agent 180a may be the same as, or different from, the respective capability associated with the second AI agent 180b. The second AI agent 180b performs the second agentic task 162b to produce second task results 182, 182b.

After performing the second agentic task 162b, the planner 160 determines whether each agentic task 162 of the plurality of agentic tasks 162 is complete. Completion, in this context, means that every agentic task 162 required to satisfy the intents 104, considering any dependencies 164 and the evolving conversational context 106, has reached a final status (e.g., successful execution, handled error, or determined no longer need based on prior results). In the example shown, the planner 160 determines that each agentic task 162 of the plurality of agentic tasks 162 is complete based on performance of the first agentic task 162a and the second agentic task 162b. Based on determining that the plurality of agentic tasks 162 is complete, the virtual assistant 150 generates the results 155 for the user query 102. The results 155 may include synthesizing relevant information extracted from the various task results 182 (e.g., 182a, 182b, and any others performed) collected throughout the execution sequence. The synthesis process may include combining data, summarizing information, or formatting the output into a coherent and user-understandable response suitable for presentation to the user 10 via the user interface 170.

In some scenarios arising during the execution of a user query 102, the planner 160 determines that the first task result 182a produced from performing the first agentic task 162a does not directly lead to the next logical step but instead presents multiple distinct options that require user clarification or selection to proceed meaningfully. These scenarios may occur when the user query 102 lacks specificity or when multiple valid possibilities are presented. To that end, the virtual assistant 150 transmits data 184 representing the multiple distinct options to the user device 110 associated with the user query 102 via the user interface 170. The user 10 may then provide an input selection 172 via the user interface 170, indicating the user selection among the options or providing the necessary clarifying information. In this interactive scenario, the planner determines the second agentic task 162b (or the next agentic task 162) to perform further based on the input selection 172.

As such, the input selection 172 ensures the ongoing workflow aligns precisely with the intent of the user 10 when faced with choices or ambiguity. For instance, for the user query 102 of “Find the latest presentation shared by Chris,” if the first agentic task 162a, executed by a file-searching AI agent 180, identifies two recent presentations associated with different colleagues named “Chris” (e.g., “Chris Miller” and “Chris Lee”), the task result 182 would reflect this ambiguity. Thus, the virtual assistant 150 presents these options via the data 184 to the user 10 (e.g., displaying “Did you mean the presentation from Chris Miller or Chris Lee?”). Upon receiving the input selection 172 from the user 10 (e.g., the user 10 clicks or says “Chris Miller”), the planner 160 utilizes this disambiguation to determine the second agentic task 162b, such as “Retrieve the specific presentation shared by Chris Miller.”

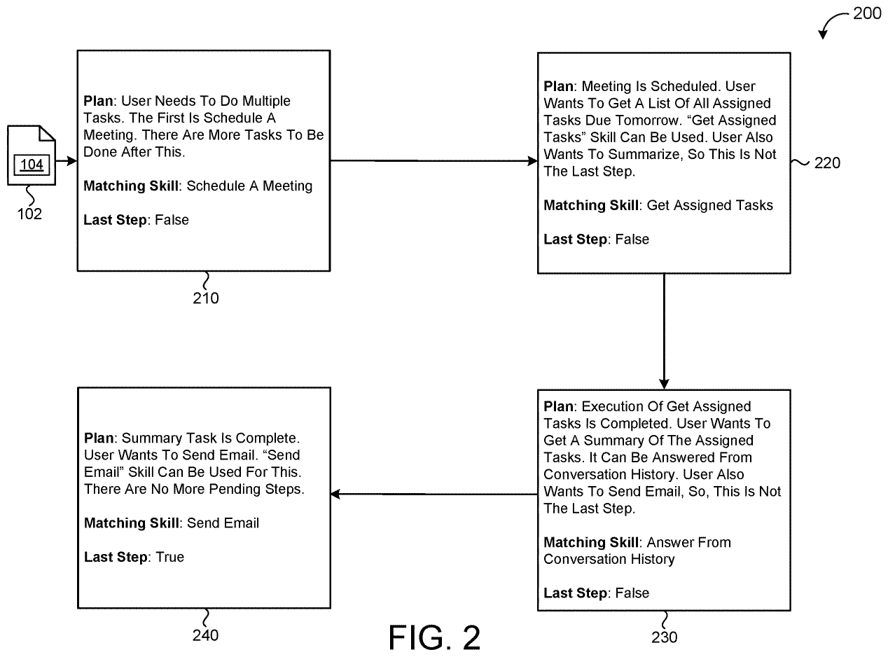

FIG. 2 illustrates an example process 200 performed by the query orchestrator 105 (FIG. 1) using the virtual assistant 150 and the planner 160 to resolve a user query 102 that includes multiple intents 104. In this example, the user query 102 is “I am on PTO tomorrow. Can you reschedule my meeting with John Jason to the day after tomorrow? Also, get all tasks assigned to me which are due tomorrow and summarize it. Email the first task summary to Jacob and the second task summary to Maria.” At step 210, the planner 160 receives and analyzes the user query 102 to identify the plurality of intents 104 implied by the user query 102. Here, the intents 104 include rescheduling a meeting with John Jason, retrieving assigned tasks due tomorrow, summarizing the retrieved tasks, emailing the summary of the first task to Jacob, and emailing the summary of the second task to Maria. Based on the user query 102, which forms part of the conversational context 106, the planner 160 determines the immediate next agentic task 162 to perform. In this instance, considering factors such as the temporal reference “PTO tomorrow,” the planner 160 prioritizes rescheduling the meeting over other agentic tasks 162. The planner 160 generates a structured output 166 with the CoT reasoning (e.g., “user query requests multiple actions. Rescheduling the meeting has near-term implications due to PTO. First action is rescheduling.”) and an identification 168 of the first agentic task 162a “reschedule meeting with John Jason to the day after tomorrow.” Subsequently, the planner 160 selects a first AI agent 180a (e.g., a scheduling agent) from the plurality of AI agents 180 whose capabilities match the requirements of the first agentic task 162a. The selected first AI agent 180a then executes the first agentic task 162a.

At step 220, upon completion of the first agentic task 162a, the first AI agent 180a provides first task results 182a (e.g., confirmation of the rescheduled meeting, or potential conflicts requiring clarification). The planner 160 updates the conversational context 106 with the first task results 182a. Based on the updated conversational context 106 (which now includes the user query 102 and the first task results 182a) and the remaining unaddressed intents 104 from the user query 102, the planner 160 determines the next agentic task 162. The planner 160 identifies that retrieving assigned tasks is the next logical step required by the user query 102 and that further actions (summarization, emailing) depend on the retrieval of the assigned tasks. The planner 160 generates a new structured output 166 with CoT reasoning of “meeting successfully rescheduled. The user also requested assigned tasks due tomorrow. Need to retrieve these tasks before summarization. Next action is task retrieval.” and identification 168 of the second agentic task 162b “retrieve all tasks assigned to the user due tomorrow.” The planner 160 then selects a second AI agent 180b (e.g., a task management agent connected to relevant data sources) from the plurality of AI agents 180 based on the suitability of the second AI agent 180b for performing agentic task 162b. The selected second AI agent 180b executes the second agentic task 162b.

At step 230, the second AI agent 180b completes the task retrieval and provides second task results 182b, which include the list of assigned tasks due tomorrow. For example, the second task results 182b may include “The first task is to create a detailed sales report highlighting the impact of a product on overall revenue, including details on customer sentiment and general output (e.g., feedback, performance data, usage metrics) about the new feature. The second task is to create an expense report for the customer site visit to Japan and submit it for approval.” The planner 160 incorporates the second task results 182b into the evolving conversational context 106. Referencing the updated conversational context 106, the planner 160 determines that the next required action derived from the user query 102 is to summarize the retrieved tasks. The planner 160 generates another structured output 166 with CoT reasoning of “Task list retrieved which includes two tasks. The user requested summarization of these tasks. Next action is summarization.” and identification 168 of the third agentic task 162c: “summarize the retrieved tasks.” The planner 160 selects a third AI agent 180c (e.g., a summarization agent, potentially leveraging an LLM) capable of processing the task list present in the conversational context 106. The selected third AI agent 180c performs the third agentic task 162c, using the retrieved task list from the task results 182 (now part of the conversational context 106) as input.

At step 240, following the completion of the summarization third agentic task 162c, the third AI agent 180c returns third task results 182c (e.g., the summarized versions of the first and second tasks). The planner 160 updates the conversational context 106 accordingly. Analyzing the context, the planner 160 identifies the remaining intents 104 from the user query 102 of emailing the first task summary to Jacob and the second task summary to Maria. The planner 160 determines the fourth agentic task 162d of “email summary of first task to Jacob.” The planner 160 generates a corresponding structured output 166 with CoT reasoning of “Summarization complete. The user requested emailing the first summary to Jacob. Next action is emailing Jacob.” and identification 168 of the fourth agentic task 162d. The planner 160 selects a fourth AI agent 180d (e.g., an email agent) based on the capability of the fourth AI agent 180d to send emails and provides the fourth AI agent 180d with the necessary parameters extracted from the context (recipient: Jacob, with the summary of the first task). The fourth AI agent 180d executes the fourth agentic task 162d. Subsequently, the planner 160 determines the fifth agentic task 162e of “email summary of second task to Maria,” selects the fifth AI agent 180e, and initiates execution of the fifth AI agent 180e. After determining that all derived agentic tasks (e.g., 162a-162e) originating from the user query 102 are complete, the virtual assistant 150 determines that the user query 102 is resolved and generates results 155 for the user 10, confirming all actions taken.

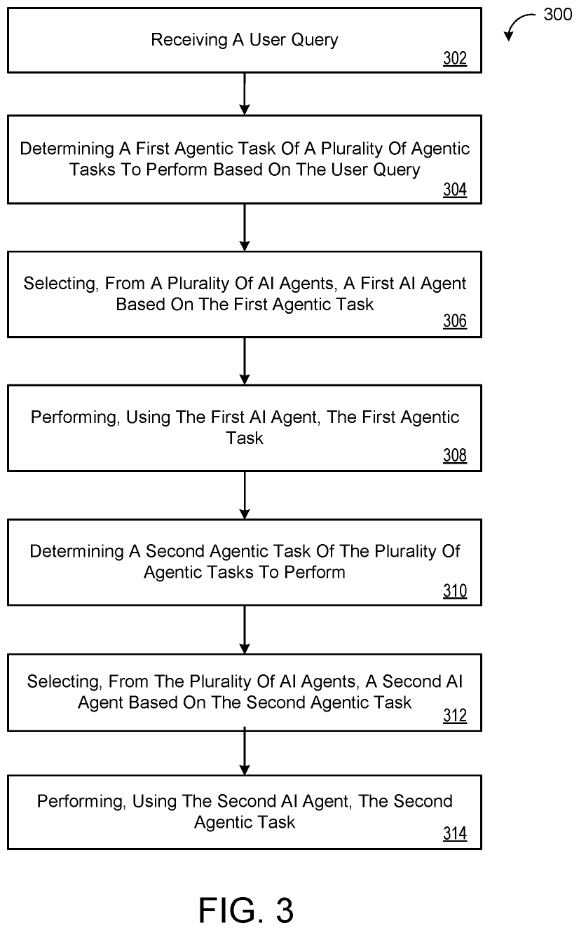

FIG. 3 is a flowchart of an exemplary arrangement of operations for a computer-implemented method 300 of orchestrating multi-agent workflows. At operation 302, the method 300 includes receiving a user query 102. At operation 304, the method 300 includes determining a first agentic task 162a of a plurality of agentic tasks 162 to perform. At operation 306, the method 300 includes selecting a first AI agent 180a from a plurality of AI agents 180 based on the first agentic task 162a. At operation 308, the method 300 includes performing, using the first AI agent 180a, the first agentic task. At operation 310, the method 300 includes determining a second agentic task 162b of the plurality of agentic tasks 162 to perform based on the user query 102 and performance of the first agentic task 162a. At operation 312, the method 300 includes selecting a second AI agent 180b from the plurality of AI agents 180 based on the second agentic task 162b. At operation 314, the method 300 includes performing, using the second AI agent 180b, the second agentic task 162b.

Thus, the query orchestrator 105 provides improvements in responding to a user query 102 with a plurality of intents 104 compared to conventional approaches. By dynamically determining a single next agentic task 162 based on the current state and prior results, the query orchestrator 105 avoids the substantial computational expense (e.g., processing cycles, memory allocation) inherent in generating complete, potentially speculative execution plans upfront. Iterative planning directly translates to reduced latency before the query orchestrator 105 initiates the first agentic task 162a and minimizes wasted computational resources that would otherwise be spent on generating plan segments subsequently invalidated by runtime events or errors. Consequently, the query orchestrator 105 operates more efficiently, conserving processing power and memory, and delivers a more responsive interaction.

Moreover, the context-aware orchestration enhances the operational resilience and adaptability of the query orchestrator 105 when faced with the inherent uncertainties of complex task execution involving multiple AI agents 180 and dependencies 164 between tasks. Unlike pre-planned task sequences that may fail entirely upon encountering an unexpected intermediate result or when user clarification is required, the query orchestrator 105 is able to re-evaluate and determine the next best agentic task 162 after each step, enabling graceful error handling, integration of new information (e.g., from RAG or user input), and dynamic adjustment of the execution path. This improves the reliability of the underlying computational process for resolving multi-intent queries, allowing the query orchestrator 105 to successfully manage complex workflows and dependencies 164 between the plurality of AI agents 180 more effectively than systems relying on static or fully pre-determined plans.

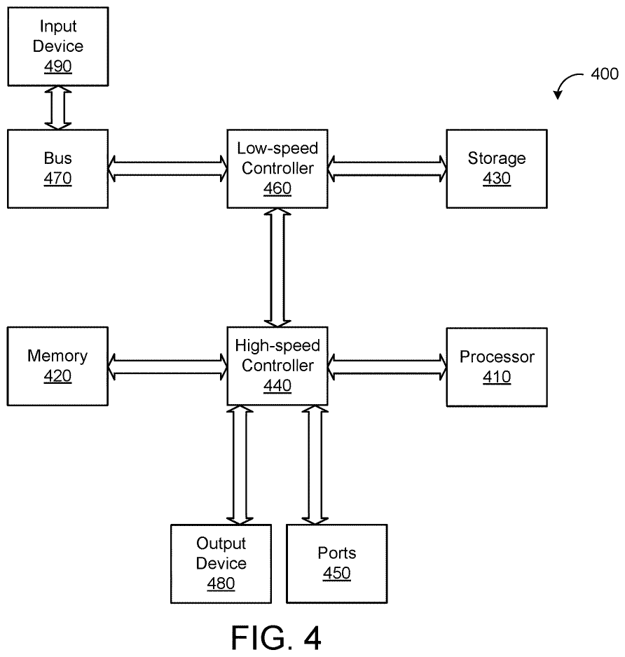

FIG. 4 is a schematic view of an example computing device 400 that may be used to implement the systems and methods described in this document. The computing device 400 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 400 includes a processor 410, memory 420, a storage device 430, a high-speed interface/controller 440 connecting to the memory 420 and high-speed expansion ports 450, and a low-speed interface/controller 460 connecting to a low-speed bus 470 and a storage device 430. Each of the components 410, 420, 430, 440, 450, and 460, are interconnected using various busses, and may be mounted on a common motherboard or in other manners as appropriate. The processor 410 can execute instructions for performing operations within the computing device 400, including instructions stored in the memory 420 or on the storage device 430 to display graphical information for a graphical user interface (GUI) on an external input/output device, such as display 480 coupled to high-speed interface 440. In other implementations, multiple processors and/or multiple buses may be used, as appropriate, along with multiple memories and types of memory. Also, multiple computing devices 400 may be connected, with each device providing portions of the necessary operations (e.g., as a server cluster, a group of blade servers, or a multi-processor system).

The memory 420 stores information within the computing device 400. The memory 420 may be a non-transitory computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 430 is capable of providing mass storage for the computing device 400. In some implementations, the storage device 430 is a non-transitory computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 420, the storage device 430, or memory on processor 410.

The high-speed controller 440 manages bandwidth-intensive operations for the computing device 400, while the low-speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port or input device 490. The low-speed expansion port 490, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
receiving a user query;
determining, based on the user query, a first agentic task of a plurality of agentic tasks to perform;
selecting, from a plurality of artificial intelligence (AI) agents, a first AI agent based on the first agentic task;
performing, using the first AI agent, the first agentic task;
based on the user query and performance of the first agentic task, determining a second agentic task of the plurality of agentic tasks to perform;
selecting, from the plurality of AI agents, a second AI agent based on the second agentic task; and
performing, using the second AI agent, the second agentic task.

2. The method of claim 1, wherein selecting the first AI agent is based on a respective capability associated with the first AI agent, wherein selecting the second AI agent is based on a respective capability associated with the second AI agent, and wherein the respective capability associated with the first AI agent is different from the respective capability associated with the second AI agent.

3. The method of claim 1, wherein the user query includes a plurality of intents, wherein the first agentic task is associated with a first intent of the plurality of intents, and wherein the second agentic task is associated with a second intent of the plurality of intents.

4. The method of claim 3, wherein determining the first agentic task comprises:
identifying dependencies between the plurality of intents; and
prioritizing tasks based on the identified dependencies.

5. The method of claim 1, further comprising:
determining that each agentic task of the plurality of agentic tasks is complete; and
based on determining that each agentic task of the plurality of agentic tasks is complete, generating results for the user query.

6. The method of claim 1, wherein determining the first agentic task is further based on a conversational context associated with the user query, the conversational context comprising information from one or more previously performed agentic tasks and one or more previously received user queries.

7. The method of claim 6, wherein determining the first agentic task comprises generating, using a large language model (LLM), a structured output comprising a chain of thought (CoT) reasoning and an identification of the first agentic task, the CoT reasoning analyzing the user query and the conversational context.

8. The method of claim 1, wherein the plurality of AI agents comprises at least one of:
a task management agent;
a summarization agent;
an email agent;
a scheduling agent; or
a question answering agent.

9. The method of claim 8, wherein the question answering agent is configured to utilize retrieval-augmented generation (RAG) based on one or more knowledge sources.

10. The method of claim 1, further comprising:
performing a semantic search based on the user query; and
retrieving supplemental information based on the semantic search,
wherein determining the first agentic task is further based on the supplemental information.

11. The method of claim 1, wherein determining the first agentic task comprises determining to route the first agentic task to at least one of:
a RAG pipeline;
a respective AI agent utilizing only a conversational context; or
a respective AI agent configured to perform the first agentic task.

12. The method of claim 1, further comprising:
determining that a task result of performing the first agentic task presents multiple distinct options requiring user selection to proceed;
transmitting data representing the multiple distinct options to a user device associated with the user query; and
receiving an input selection indicating the user selection.

13. The method of claim 12, wherein determining the second agentic task of the plurality of agentic tasks to perform is further based on the input selection.

14. The method of claim 1, further comprising, before determining the second agentic task, determining that each agentic task of the plurality of agentic tasks is not complete, wherein determining the second agentic task is further based on determining that each agentic task of the plurality of agentic tasks is not complete.

15. The method of claim 1, wherein performing the first agentic task comprises generating a task result based on performing the first agentic task.

16. The method of claim 15, wherein determining the second agentic task is further based on the task result.

17. The method of claim 1, wherein the first agentic task comprises a next best action.

18. The method of claim 1, wherein determining the second agentic task occurs after performing the first agentic task.

19. A system comprising:
data processing hardware; and
memory hardware in communication with the data processing hardware, the memory hardware storing instructions that when executed on the data processing hardware cause the data processing hardware to perform operations comprising:
receiving a user query;
determining, based on the user query, a first agentic task of a plurality of agentic tasks to perform;
selecting, from a plurality of artificial intelligence (AI) agents, a first AI agent based on the first agentic task;
performing, using the first AI agent, the first agentic task;
based on the user query and performance of the first agentic task, determining a second agentic task of the plurality of agentic tasks to perform;
selecting, from the plurality of AI agents, a second AI agent based on the second agentic task; and
performing, using the second AI agent, the second agentic task.

20. A computer-readable medium having instructions that, when executed by data processing hardware, causes the data processing hardware to perform operations comprising:
receiving a user query;
determining, based on the user query, a first agentic task of a plurality of agentic tasks to perform;
selecting, from a plurality of artificial intelligence (AI) agents, a first AI agent based on the first agentic task;
performing, using the first AI agent, the first agentic task;
based on the user query and performance of the first agentic task, determining a second agentic task of the plurality of agentic tasks to perform;
selecting, from the plurality of AI agents, a second AI agent based on the second agentic task; and
performing, using the second AI agent, the second agentic task.
